(19) United States
(12) Patent Application Publication
(10) Pub. No.: US 2013/0132291 A1
(43) Pub. Date: May 23, 2013

(54) ASSESSING AGREEMENT COMPLIANCE

(71) Applicants: Tracy R. Beal, Victor, NY (US); David A. Hill, Jacksonville, FL (US); Monica M. Pierce, Charlotte, NC (US); Erin M. McCullen, Charlotte, NC (US)

(72) Inventors: Tracy R. Beal, Victor, NY (US); David A. Hill, Jacksonville, FL (US); Monica M. Pierce, Charlotte, NC (US); Erin M. McCullen, Charlotte, NC (US)

(73) Assignee: Bank of America, Charlotte, NC (US)

(21) Appl. No.: 13/302,113

(22) Filed: Nov. 22, 2011

(51) Int. Cl. G06Q 99/00

(52) U.S. Cl. 705/317

(57) ABSTRACT

Systems and methods for assessing compliance of a financial institutions implementation of an agreement are provided. Compliance may assessed by comparing an effects of a production cycle implementation of an attribute of the agreement to an effect of a test environment implementation of the attribute of the agreement. The assessing may include performing a first pairing of the attribute to a financial product, and monitoring an effect of the first pairing on the financial product. The method may include performing a second pairing of the attribute to a financial product and monitoring an effect of the second pairing on the financial product. The method may include comparing the effect of the first pairing to the effect of the second pairing and based on the comparing, determining whether the financial institution is in compliance with the agreement.

### CROSS-REFERENCE TO RELATED APPLICATION

Application Ser. No. 13/213,478 filed, on Aug. 19, 2011, is hereby incorporated by reference in its entirety.

### FIELD OF TECHNOLOGY

Aspects of the present disclosure relate to assessing compliance with an agreement to which a financial institution is a party.

### BACKGROUND

This disclosure relates to ensuring that the financial institution satisfies its obligations—i.e., it fulfills a commitment—to a counter-party.

The counter-party may include a customer. At times, a customer of the financial institution may discover an anomalous treatment of a financial product, such as accounts, prior to identification of such treatment by the financial institution holding the accounts. Such anomalous behavior may deprive the customers of funds owed to them under an agreement or commitment. Prior discovery by customers of such deprivation creates ire on the part of the customer.

It would be desirable to provide systems and methods that ensure satisfaction of customer expectations and ensure compliance with relevant agreements or commitments.

It would be further desirable to help quickly detect anomalous behavior, preferably prior to customer detection.

It would be still further desirable to identify systematic inefficiencies, reduce foregone revenues, minimize undue refunds and minimize operational losses attributable to quality-related defects in the area of payment processing and handling of customer accounts.

### SUMMARY

This disclosure provides systems and methods for assessing with an agreement between a financial institution and a counter-party. The counter party may be a customer of the financial institution. The method may include storing in a machine readable memory an attribute associated with the agreement and a financial product. The method may include validating the storing.

The method may include performing a first pairing of the attribute to the financial product and monitoring an effect of the first pairing on the financial product. The method may include performing a second pairing of the attribute to the financial product and monitoring an effect of the second pairing on the financial product.

The method may include comparing the effect of the first pairing to the effect of the second pairing and based on the comparing, determining whether the financial institution is in compliance with the agreement.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative information that may be used in accordance with principles of the invention;

FIG. 2 shows illustrative information that may be used in accordance with principles of the invention;

FIG. 3 shows illustrative information that may be used in accordance with principles of the invention;

FIG. 4 shows illustrative information that may be used in accordance with principles of the invention;

FIG. 5 shows illustrative information that may be used in accordance with principles of the invention;

FIG. 6 shows illustrative information that may be used in accordance with principles of the invention;

FIG. 7 shows an illustrative process in accordance with principles of the invention; and

FIG. 8 shows a schematic diagram of a general purpose digital computing environment in which one or more aspects of the present invention may be implemented.

### DETAILED DESCRIPTION OF THE DISCLOSURE

Apparatus and methods for assessing compliance with an agreement are provided. The agreement may include an agreement that is not currently in effect. The agreement may include a tentative agreement that the financial institution is contemplating entering at a future time. The agreement may include an attribute.

The agreement may involve a financial product. The financial product may be a financial instrument, an account held at the financial institution or any suitable financial product. Exemplary financial products may include interest-bearing checking, savings, certificate of deposit (“CD”) and individual retirement account (“IRA”) products.

The attribute may include an identifier. The identifier may be associated with the financial product. The identifier may be associated with one or more financial products.

The attribute may include a pricing scheme. The pricing scheme may include a rate of interest, a fee schedule, a fee for providing a financial service, a promotional financial arrangement or any suitable pricing scheme. The attribute may include any suitable pricing scheme that affects performance of the financial product.

The apparatus may include one or more non-transitory computer-readable media storing computer-executable instructions. A processor device may be configured to execute the instructions. When executed by the processor device, the instructions may perform a method for assessing compliance of an agreement of a financial institution. The agreement may include the attribute.

For example, the agreement may include an offer by the financial institution to provide a financial product that performs in accordance with the pricing scheme. The agreement may include a special offer. The special offer may be a non-contractual affinity code (“NCA”). The NCA may include a pricing scheme. The attribute may include the special offer. The attribute may include the NCA.

The method may include storing information in a machine readable memory. The information may include the attribute and the financial product.

The method may include validating. The validating may include validating the storing. The validating may include validating the information. The validating may occur before the information is stored in the machine readable memory. The validating may occur after the information is stored in the machine readable memory, or simultaneously thereto.

The validating may include identifying an invalid attribute. The validating may include identifying an invalid financial product. Identifying an invalid attribute and/or invalid financial product may include identifying an attribute erroneously associated with a financial product.

For example, due to data processing error an attribute identifier may be erroneously associated with a financial product. The data processing error may arise due to a human error, a data storage error or any other suitable error.

The validating may reduce and/or be used to correct a number of erroneous entries of information into the machine readable memory. The validating may reduce and/or be used to correct a number of invalid attributes and invalid financial products stored in the machine readable memory.

The validating may include generating a report. The report may include a record of the information stored in the machine readable memory. The validating may include an analysis of the record. The analysis may include a visual inspection.

The report may include a record of updates to the information stored in the machine readable memory. The validating may include an analysis of the record of updates. The analysis may include a visual inspection of the records.

The report may include a record of the attribute. The report may include a financial product associated with the attribute. The report may include a name of an individual responsible for storing the attribute. The report may include a name of an individual responsible for authorizing a pairing of the attribute and the financial product.

For example, the validating may include verifying that an NCA is associated only with financial products that are authorized to be paired with the NCA. An NCA that is associated with a financial product that is not authorized to be paired with the NCA may be an invalid NCA. A financial product that is associated with an NCA that is not authorized to be paired with the financial product may be an invalid financial product.

If the NCA does not correspond to an NCA authorized to be paired with the financial product, an exception report may be generated. The validating may include a review of the exception report. The exception report may be generated based on comparing an attribute associated with a financial product that is stored in the machine readable memory with a master list of attribute and financial product associations.

The exception report may include a matrix, display or other compendium of information. Such information may include: the NCA reviewed, the financial product reviewed and whether the exceptional account was related to any particular special offer within the financial institution. The validating may include listing the total number of exceptions for each individual NCA, financial product and/or any other suitable metric.

The method may include performing a first pairing of the attribute to the financial product. For example, a financial product, such as a savings account, may be paired with an attribute, such as an NCA. The pairing of the savings account and the NCA may correspond to a savings account that accrues interest at a pre-determined rate. The pre-determined rate may correspond to a pricing scheme of the NCA. The pre-determined rate may be different from a rate of interest of a savings account that is not paired with the NCA.

The method may include monitoring an effect of the first pairing on the financial product. The first pairing may result in a financial product performing in accordance with a pricing scheme of the attribute.

The effect may include a change to total account balances, interest paid, interest accrued month-to-date (“MTD”), total fees or any suitable effect. For example, the effect may correspond to accrual of interest at a pre-determined rate. As a further example, the effect may correspond to a fee changed for using a service offered by the financial institution.

The method may include performing a second pairing of the attribute to the financial product. The second pairing may include one or more characteristics of the first pairing. The second pairing may include pairing a different attribute and/or a different financial product from the first pairing.

The method may include monitoring an effect of the second pairing. The effect of the second pairing may include one or more characteristics of the effect of the first pairing.

The method may include comparing the effect of the first pairing to the effect of the second pairing. For example, the effect of the first pairing may correspond to a first rate of interest that accrues on funds held in a savings account. The effect of the second pairing may correspond to a second rate of interest that accrues on funds held in the savings account. The comparing may include comparing the first rate of interest to the second rate of interest.

The comparing may identify and record differences between the effect of the first pairing and the effect of the second pairing. The differences may be placed into a suitable output format and then output. In some embodiments, only differences of a pre-determined threshold amount may be included in the output.

The comparing may occur at any suitable, preferably pre-determined, interval of time. For example, the comparing may occur daily. Periodic comparing may provide an early warning tool for recognizing an unanticipated effect of a pairing of a financial product and an attribute.

Based on the comparing, the method may include determining whether the financial institution is in compliance with the agreement. The determining may include examining whether the effect of the first pairing corresponds to the effect of the second pairing. The determining may include examining whether the effect of the first pairing is different from the effect of the second pairing.

In an exemplary embodiment, the agreement may include a commitment by the financial institution to provide a financial product that performs in accordance with an attribute of the agreement. The financial institution may seek to comply with the commitment by authorizing a pairing of the financial product and the attribute. A pairing of the financial product and the attribute may result in a financial product that performs in accordance with the financial institution, as required by the agreement.

If the effect of the first pairing corresponds to the effect of the second pairing, the financial institution may comply with the agreement because the financial product performs in accordance with the attribute of the agreement. If the effect of the first pairing does not correspond to the effect of the second pairing, the financial institution may fail to comply with the agreement because the financial product is not performing in accordance with the attribute of the agreement.

In some embodiments the first pairing and the second pairing may occur in a testing environment. In some embodiments the first pairing and the second pairing may occur in a live environment.

In some embodiments, the first pairing may occur in a testing environment and the second pairing may occur in a live environment.

The testing environment may include one or more financial products. The testing environment may include one or more financial products and/or attributes that are currently available to customers of the financial institution. The testing environment may include one or more financial products and/or attributes that are not available to customers of the financial institution. The testing environment may include one or more financial products and/or attributes that may be available to customers of the financial institution at a future time.

The testing environment may be constructed based on actual financial products and/or attributes. The testing environment may be constructed based on theoretical financial products and/or attributes. For example, the first pairing in the testing environment may simulate a pairing of a financial product and an attribute, both of which are currently available to customers of the financial institution.

The first pairing may include applying a pricing scheme of the attribute to the financial product in the testing environment. The second pairing may include applying the pricing scheme to the financial product in the live environment.

The testing environment may be selected to monitor an effect of the first pairing under various conditions. The testing environment may be constructed based on the live environment. The testing environment may correspond to the live environment. For example, the testing environment may include one or more financial products that are currently offered by the financial institution.

The testing environment may be selected to confirm the validating. Despite the validating, the attribute or the financial product may have been incorrectly stored in the machine readable memory. A pairing including the incorrectly stored attribute or financial product may produce an effect that is unanticipated. An unanticipated effect may result in the financial institution failing to comply with an agreement.

The testing environment may be selected to include one or more invalid attributes and one or more invalid financial products. The invalid attributes or invalid financial products may simulate incorrectly stored attributes or incorrectly stored financial products. The invalid attributes or invalid financial products may simulate an attribute erroneously associated with a financial product.

The testing environment may be selected to include one or more attributes and one or more financial products not associated with each other. The testing environment may be selected to include one or more attributes and one or more financial products that are erroneously associated with each other.

For example, the identifier of an NCA may not be associated with a particular form of savings account. As a further example, an NCA may be limited in geographic scope. A customer of the financial institution having a home address outside a geographic boundary may be ineligible for a pairing of the NCA and a financial product. For example, such a geographic boundary may be defined by a location within a state.

The pairing in the testing environment may test whether an invalid pairing may occur. An invalid pairing may include a pairing of a financial product with the non-associated or the erroneously associated attribute. An invalid pairing may include a pairing including an invalid financial product or an invalid attribute. An invalid pairing may include any pairing that results in an unanticipated effect on performance of a financial product.

For example, an association of an attribute and a financial product may be included in a master list. Processing of the master list may corrupt the master list. Processing may include storing, copying, parsing, updating, appending, deleting or any suitable data processing operation. A corrupt master list may include an erroneous association of an attribute and a financial product not found in the master list.

An invalid pairing may occur because of an error in processing the attribute, the financial product the pairing or any other suitable processing error. An invalid pairing may result in an unanticipated effect on a financial product.

Unanticipated effects may include altering a performance of a financial product, non-compliance with an agreement or monetary loss to the customer or the financial institution. For example, a pairing may change the rate at which an IRA account accrues interest. A pairing may change an interest rate because an attribute may include a pricing scheme.

An unanticipated effect may include a mismatched branding of a financial product. For example, an image may be associated with an attribute. A pairing of the attribute to a financial product, such as a credit card, debit card or check may result in the image being printed on the financial product. Mismatched branding may include a financial product that includes a printed image that is not associated with the attribute paired to the financial product.

The testing environment may be selected to confirm that invalid pairings do not occur. For example, the first pairing may include attempting to pair a checking account and an NCA. The pairing may be invalid because the selected NCA includes a restriction on pairing with the checking account.

If the attempted pairing of the checking account and NCA is unsuccessful, the financial institution may receive confirmation that an invalid pairing did not occur. For example, if after attempting a pairing of a financial product and an NCA, the financial product does not perform in accordance with a pricing scheme of the NCA, the pairing was unsuccessful.

However, if the attempted invalid pairing is successful, the financial institution may receive notice of possible non-compliance with an agreement. A successful invalid pairing of a financial product and an NCA may indicate non-compliance or inconsistent compliance of the financial institution with an agreement.

In some embodiments, the effect of the first pairing in the testing environment may determine compliance with implementation of a future agreement. The effect of the first pairing in the testing environment exemplifies an effect that will occur when the pairing takes place in a live environment. If the effect of the first pairing in the testing environment is an unanticipated effect, the financial institution may eliminate the unanticipated effect prior to implementation of the future agreement. The unanticipated effect may indicate that the financial institution does not comply with the future agreement.

The comparing may compare the effect of the first pairing to a pre-determined value. The comparing may compare the effect of the second pairing to a pre-determined value. The pre-determined value may include an interest rate, an account balance or any suitable value.

The comparing may compare the effect of the first pairing in the testing environment to the effect of the second pairing in the live environment. The comparing may include identifying an invalid pairing.

For example, in the testing environment, a pairing may result in a financial product accruing interest at a rate of 5%. In the live environment, the identical pairing may result in financial product accruing interest at a rate of 6%. The different accrual rates may indicate that the pairing, the attribute or the financial product may be invalid. The different accrual rates indicate that the financial institution may not be in compliance with an agreement.

In some embodiments, the identifying may be based upon a detection of an invalid pairing between the attribute and the financial product. For example, an NCA may include a restriction on which financial product the NCA may be associated. The restriction may be included in a master list of NCAs. For each NCA, the master list may include financial products that may be validly associated with the particular NCA.

The identifying may include comparing a pairing of a financial product and an attribute to the restriction included in the master list. If the pairing includes a financial product not on the master list, the pairing may be invalid.

An effect of the first pairing may be compared to an effect of the second pairing. The effect of the first pairing in the testing environment may be anticipated and the effect of the second pairing in the live environment may be unanticipated. The effect of the second pairing in the live environment may be influenced by a variable not present in the testing environment. The variable may include human error, financial products that include more than one pairing with different attributes or any suitable variable.

The comparing may identify, or help identify, the variable present in the live environment and not in the testing environment. The comparing may identify, or help identify, a variable present in the testing environment and not in the live environment.

The determining of whether the financial institution is in compliance with the agreement may include determining whether an effect of the pairing of the attribute and the financial product is in compliance with the agreement.

For example, the testing environment may be selected to examine whether an effect of the first pairing of the financial product with the attribute unanticipated. An unanticipated effect may include accruing interest at a rate higher or lower than the pricing scheme of the attribute.

The attribute may be included in a plurality of attributes. The financial product may be included in a plurality of financial products. The first pairing may include, in the testing environment, pairing each attribute to at least one financial product. The second pairing may include, in the live environment, pairing each attribute to the at least one financial product.

Pairing the plurality of attributes and the plurality of financial products may provide a plurality of effects of the pairings. The plurality of effects may include a plurality of first effects. The plurality of effects may include a plurality of second effects. The plurality of effects may indicate how consistently the financial institution complies with an agreement.

Monitoring the plurality of effects may include monitoring an effect of each first pairing. Monitoring the plurality of effects may include monitoring the effect of each second pairing. Comparing may include comparing effects of the plurality of first pairings to effects of the plurality of second pairings.

The apparatus may include one or more computer-readable media storing computer-executable instructions which, when executed by a processor on a computer system, perform a method for assessing compliance with an agreement of a financial institution.

The method may include storing in a machine readable memory an association of an attribute of the agreement with a financial product. The method may include validating the storing. The method may include applying the attribute to the financial product in a testing environment and in a live environment.

The method may include monitoring an effect of the applying on a performance of the financial product. Based on the effect, the method may include determining whether the financial institution is in compliance with the agreement.

For example, the financial institution may offer a savings account that accrues interest at a default rate. The financial institution may enter into an affiliation with another entity and offer the savings account that accrues interest at a pre-determined rate. The pre-determined rate may be different than the default rate. The financial institution may receive confirmation that the effect of the applying corresponds to the savings account accruing interest at the pre-determined rate.

Based on the effect of applying an attribute (e.g.—the determined rate of interest) to a financial product (e.g.—the savings account) the financial institution may receive notification as to whether it is in compliance with the agreement.

Validating the storing may include analyzing an authorization for the association of the attribute with the financial product. Validating may include analyzing a record. The record may include a name of an individual, organization entity or any other party responsible for authorizing association of the attribute and the financial product. The validating may include contacting the party, preferably within the entity, responsible for the authorizing.

The attribute may be included in a plurality of attributes. The financial product may be included in a plurality of financial products. Applying may include applying one of the plurality of attributes to each financial product.

The plurality of financial products may include a first financial product and a second financial product. Applying may include applying one of the plurality of attributes to the first financial product associated with the one of the plurality of attributes. The applying may include applying one of the plurality of attributes to the second financial product not associated with the one of the plurality of attributes.

For example, applying may include applying an attribute to a financial product in a testing environment. The effect of the applying may be monitored. If the association of the attribute and the financial product is authorized, the effect of the applying may be anticipated.

If the attribute does not include an authorized association with the financial product, the effect of the applying may be unanticipated. If the association is unauthorized, than the effect of applying is unanticipated. An investigation may be conducted to discover why the association occurred.

As a further example, applying may attempt to perform an invalid applying. In some embodiments, the attempt tests whether an invalid applying may occur. The invalid applying may result in an unanticipated effect and may impact compliance of the financial institution with an agreement.

For example, the financial institution may expect that a financial product may accrue interest at a rate X. An invalid applying may result in the financial product accruing interest at a rate of X+Y.

Applying in the testing environment may occur prior to the applying in the live environment. The applying in the live environment may occur prior to the applying in the testing environment. For example, applying an attribute to a financial product in a testing environment prior to applying the attribute to the financial product in the live environment may allow the financial institution to assess an effect of the applying prior to public implementation of an agreement.

Monitoring the effect of the applying may include comparing an effect of the applying in the testing environment to an effect of the applying in the live environment.

The effect of the applying may be measured by an amount of interest paid. The effect of the applying may be measured by an amount of interest accrued. The effect of the applying may be measured by an amount of total fees assessed. The effect of the applying may be measured by any suitable metric.

For example, the attribute may include a fee structure for use on/of an Automated Teller Machine (ATM). The financial product may include a debit card or a plurality of debit cards. Applying the fee structure to one of the plurality of debit cards may allow a holder of the one debit card to use an ATM without being charged a fee. Other debit cards included in the plurality of debit cards that are not included in the applying may be charged a fee to use an ATM.

Apparatus and methods may include a system for assessing compliance with an agreement between a financial institution and a customer of the financial institution. The system may include a transmitter device configured to receive an attribute of the agreement.

The attribute may be associated with a financial instrument. The system may include a machine readable memory configured to store the attribute and the financial instrument.

The system may include a processor configured to apply the attribute to the financial instrument in a testing environment. The processor may be configured to apply the attribute to the financial instrument in a live environment.

The processor may be configured to monitor a first effect of the attribute on performance of the financial instrument in the testing environment. The processor may be configured to monitor a second effect of the attribute on performance of the financial instrument in the live environment. Based on the first effect and the second effect, the processor may be configured to assess compliance of the financial institution with the agreement.

For example, the testing environment may include pre-release production data. The live environment may include post-release production data. The processor may compare an effect of applying the attribute to pre-release data and an effect of the applying the attribute to post-release data.

The processor may be configured to compare the first and second effects periodically or randomly for a pre-determined duration of time—e.g., five days. The processor may be configured to monitor the first and second effects prior to and following a release of the new product and/or product modification for a duration of time.

The first effect and the second effect may include a rate of interest associated with the financial instrument.

The processor may be configured to monitor the second effect and assess whether the performance of the financial instrument is in compliance with the agreement for a duration of the agreement.

The duration of the agreement may be defined by an expiration date of the attribute. The duration of the agreement may be defined by an expiration date of the financial instrument. The expiration date may correspond to a date in the agreement. The expiration date may correspond to a termination date of the agreement. The duration may correspond to a period of time during which the agreement is enforceable.

The processor may be configured to periodically monitor the second effect. The second effect may include an effect of the attribute on performance of the financial instrument in the live environment. The system may monitor the second effect and compare the second effect to a term of the agreement. If the second effect does not conform to the term of the agreement, the financial institution may fail to comply with the agreement. The system may monitor the second effect for a duration of the agreement.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

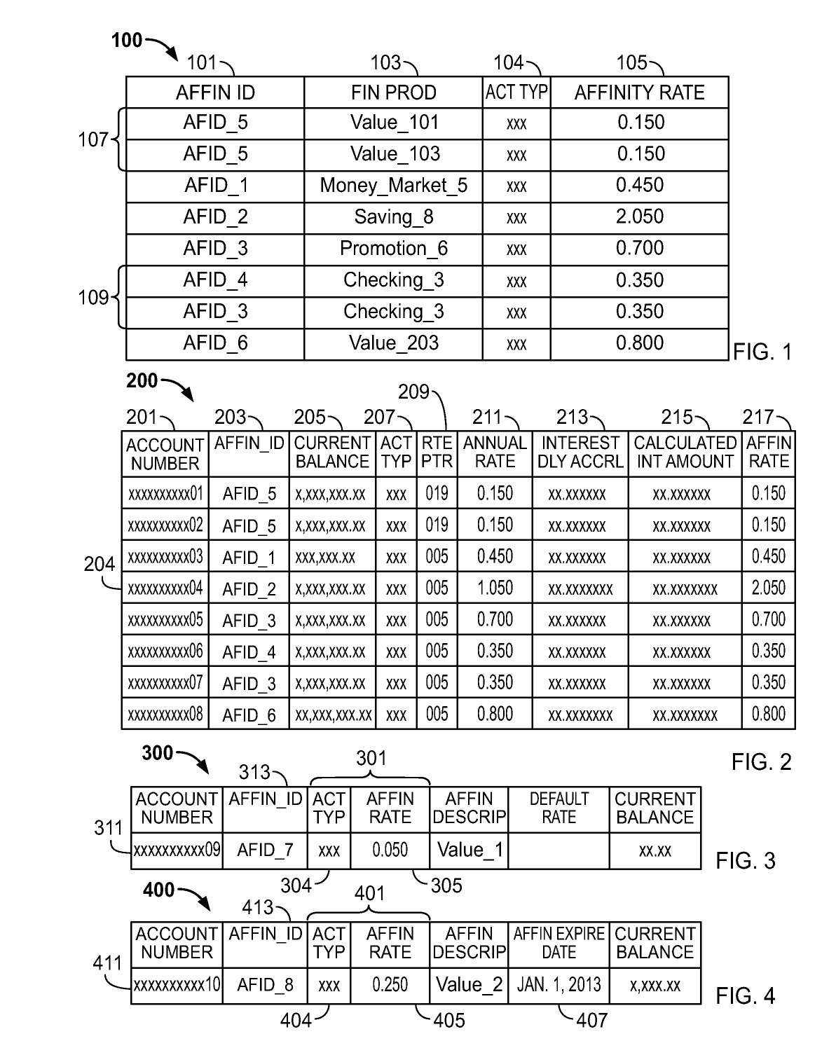

FIG. 1 shows illustrative information 100. Information 100 may correspond to a master list of attributes. Each attribute may include a Non-Contractual Affinity Code (“NCA”). Each NCA may include an affinity ID 101. Each affinity ID 101 may associate the NCA with an account type 104. Each account type 104 may correspond to a financial product 103.

Each affinity ID 101 is associated with an affinity rate 105. The affinity rate 105 may be different from a default interest rate (not shown) of financial product 103. Applying and or pairing the NCA to a financial product 103 may result in the financial product 103 accruing interest at the affinity rate 105 instead of the default rate.

Rows 107 and 109 show one or more financial products 103 associated with one or more NCA's.

FIG. 2 shows illustrative information 200. The following terminology is used regarding information 200:

### ACCOUNT NUMBER 201

AFFIN_ID 203=Affinity ID=numeric code to identify an NCA.

### CURRENT BALANCE 205

ACT TYP 207=Account Type=numeric code corresponding to a financial product.
RTE PTR 209=Rate Pointer=numeric code pointing to a tiered rate (providing different interest rate for different deposit amounts) stored in a Rate Table (not shown).

### Annual Rate 211=Annual Interest Rate.

Interest DLY ACCRL 213=Daily Interest Accrual Amount=one day's worth of interest.
CALCULATED INT AMOUNT 215=Daily interest accrual amount as calculated by monitoring an effect of pairing the affinity ID 203 and the account number 201.
AFFIN RATE 217=Affinity Rate=Interest Rate resulting from the pairing of the affinity ID 203 and the account number 201.

Each account number 201 may be paired with an affinity ID 203. An attribute of an agreement may include affinity ID 203. Each affinity ID 203 may be associated with an affinity rate 217 (see FIG. 1, items 101 and 105). A current balance 205 may be based on an effect of pairing account number 201 and affinity ID 203. The effect may include an accrual of interest calculated at the affinity rate 217. If an account number 201 is paired to an affinity ID 203, the annual rate 211 may correspond to the affinity rate 217.

The interest daily accrual rate 213 may correspond to the affinity rate 217 as applied to the current balance 205. The interest daily accrual rate 213 may correspond to the effect of a first pairing of the affinity ID 203 to the account number 201. The pairing may occur in a live environment (not shown).

The interest calculated amount 215 may correspond to an accrual of interest that is calculated independently of the interest daily accrual 213. The interest calculated amount 215 may correspond to the effect of a second pairing of the affinity ID 203 to the account number 201. The second pairing may occur in a testing environment (not shown).

The interest calculated amount 215 may be compared to the interest daily accrual 213. The annual rate 211 may be compared to the affinity rate 217. If there is a discrepancy in the amounts and/or rates of interest, the financial institution may fail to comply with an agreement requiring an account 201 to accrue interest at an affinity rate 217. Row 219 shows an illustrative discrepancy between affinity rate 217 and annual rate 211.

FIG. 3 shows illustrative information 300. Information 300 may correspond to a record of a pairing of a financial product and an attribute.

In some embodiments, the pairing may only occur with a financial product and an associated attribute. Association 301 shows that an account type 304 is associated with affinity ID 313. The account type 304 corresponds to a particular financial product (see FIG. 2, item 207). Due to an error, association 301 may be invalid. Association 301 may be validated by comparing association 301 to a master list of associations (see, e.g. FIG. 1). If association 301 is present in the list of associations, the association 301 may be invalid.

Information 300 indicates that the effect a pairing of account 311 and affinity ID 313 may be account 311 accruing interest at an affinity rate 305 of 0.050%.

FIG. 4 shows illustrative information 400. Information 400 may include association 401. Association 401 shows account type 404 associated with affinity ID 413. Information 400 indicates that the effect a pairing of account 411 and affinity ID 413 is that account 411 will accrue interest at an affinity rate 405 of 0.250%.

Information 400 may include affinity expiration date 407. An NCA may be assigned an expiration date 407. Information 400 shows that the affinity ID 413 associated with account 411 is invalid after expiration date 407. A pairing including affinity ID 413 that occurs after expiration date 407 is an invalid pairing.

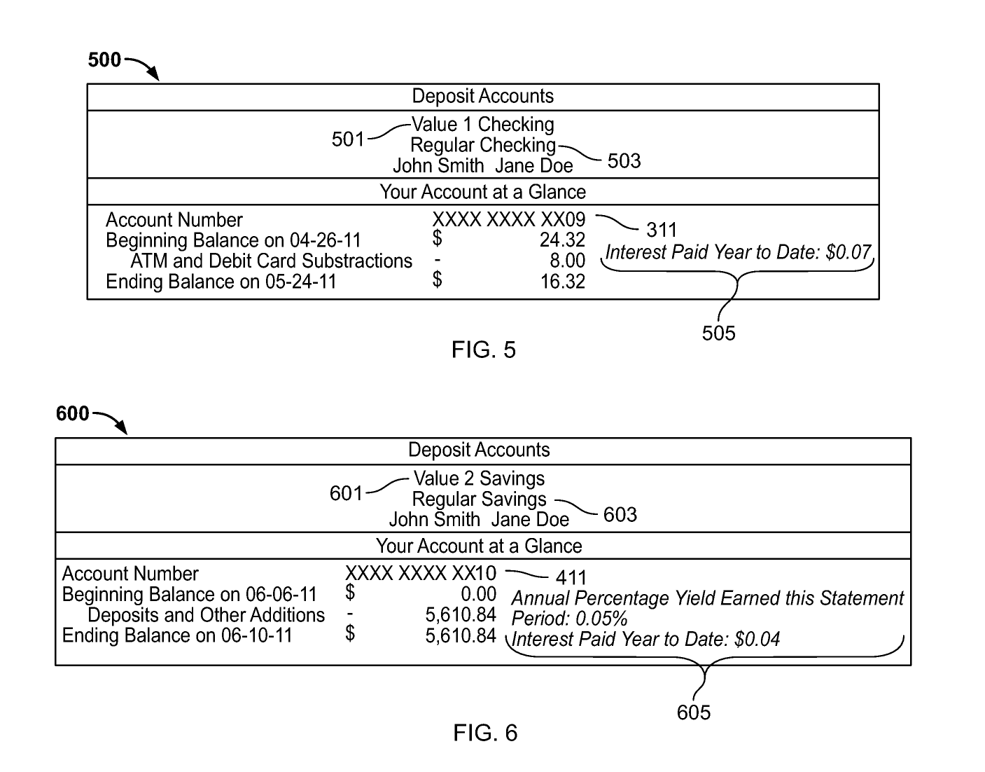

FIG. 5 shows illustrative information 500. Information 500 may include information displayed to a customer of the financial institution. The customer may be a holder of account 311 (shown in FIG. 3). Information 500 includes financial product description 503. Information 500 includes attribute description 501. Inclusion of financial product description 503 and affinity description 501 in information 500 informs the customer of a pairing of account 311 with an attribute.

Information 500 includes effect 505. Effect 505 indicates an effect of the pairing on performance of account 311. Effect 505 corresponds to an accrual of interest at a determined rate. The determined rate corresponds to affinity rate 305 (shown in FIG. 3).

FIG. 6 shows illustrative information 600. Information 600 may include information displayed to a customer of the financial institution. The customer may be a holder of account 411 (shown in FIG. 4). Information 600 includes financial product description 603. Information 600 includes attribute description 601. Inclusion of financial product description 603 and affinity description 601 in information 601 indicates a pairing of account 411 with an attribute. The attribute may be an NCA.

Information 600 includes effect 605. Effect 605 indicates an effect of the pairing on performance of account 411. Effect 605 corresponds to an accrual of interest at a determined rate. Because of the pairing of account 411 and an attribute, the determined rate should correspond to affinity rate 405 (shown in FIG. 4). However, effect 605 corresponds to an interest rate of 0.050%, and the affinity rate associated with affinity description 601 is 0.250% (see FIG. 4, item 405). Thus, effect 605 is an unanticipated effect. An unanticipated effect may indicate that a financial institution does not comply with an agreement.

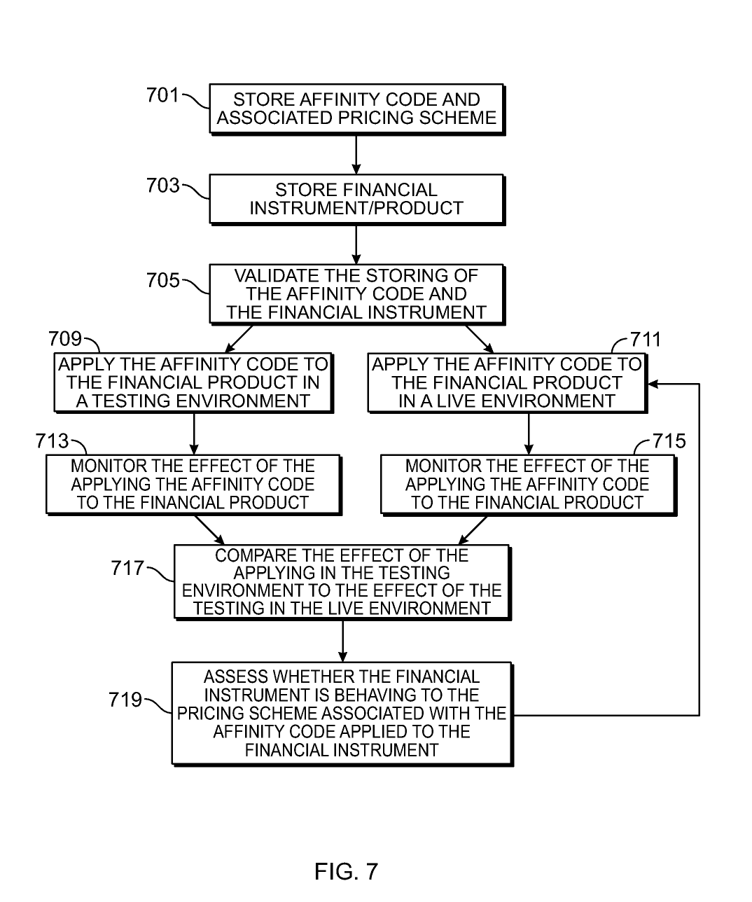

FIG. 7 shows illustrative steps that may be taken by systems and methods (referred to hereinafter, collectively, as “the system”) in accordance with principles of the disclosure. At step 701, the system may store an affinity code and a pricing scheme associated with the affinity code. At step 703, the system may store a financial instrument and/or product.

At step 705, the system may validate the storing of the affinity code and the financial instrument. Step 705 may include searching for invalid attributes, invalid financial products or invalid associations of an attribute and financial product. At step 707, the system may apply the affinity code to the financial product.

At step 709, the affinity code is applied to the financial product in a testing environment. The testing environment may include applying the affinity code to a financial product in a manner that will not affect a customer of the financial institution.

At step 711, the affinity code is applied to the financial product in a live environment. The live environment may include applying the affinity code to a financial product in manner that will affect a customer of the financial institution.

At step 713, the system monitors an effect of the applying the affinity code to the financial product in the testing environment. At step 715, the system monitors an effect of the applying the affinity code to the financial product in the live environment.

At step 717, the system compares the effect the applying in the testing environment to the effect of the applying in the live environment. Based on the comparison, at step 719 the system assesses whether the financial instrument paired to the affinity code is performing in accordance with the pricing scheme associated with the affinity code. If the system detects a discrepancy between steps 713 and 715, the financial institution may not be in compliance with an agreement that mandates application of the pricing scheme to a financial instrument after pairing the affinity code to the financial product.

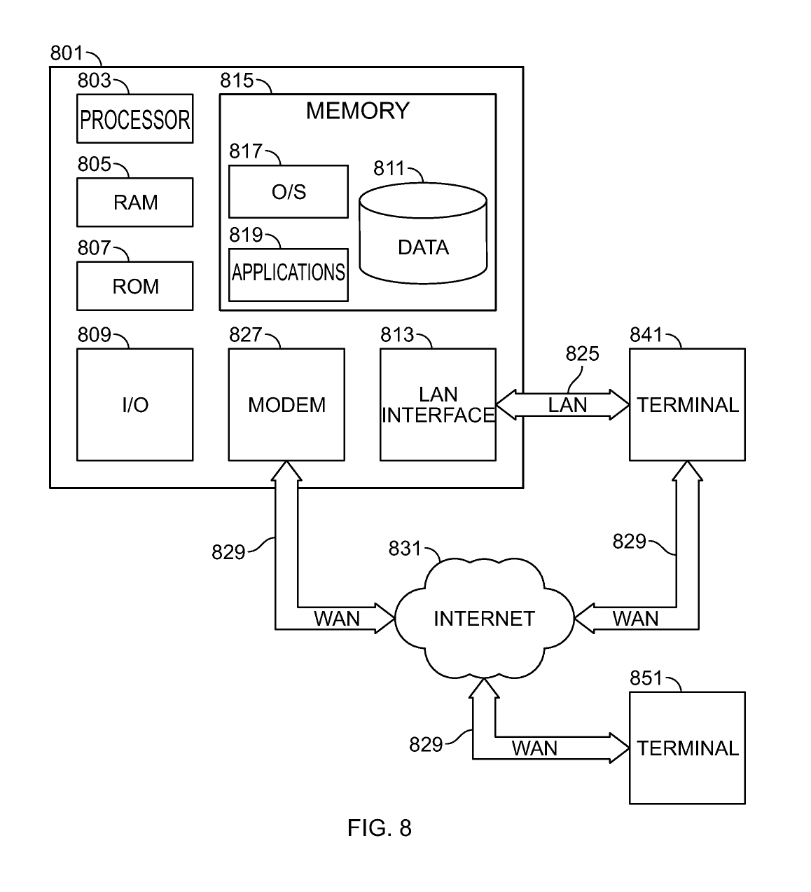

FIG. 8 is a block diagram that illustrates a generic computing device 801 (alternatively referred to herein as a “server”) that may be used in accordance with the principles of the invention. Server 801 may be included in any suitable apparatus that is shown or described herein.

Server 801 may have a processor 803 for controlling overall operation of the server and its associated components, including RAM 805, ROM 807, input/output module 809, and memory 815.

Input/output (“I/O”) module 809 may include a microphone, keypad, touch screen, and/or stylus through which a user of device 801 may provide input, and may also include one or more of a speaker for providing audio output and a video display device for providing textual, audiovisual and/or graphical output. Software may be stored within memory 815 and/or storage to provide instructions to processor 803 for enabling server 801 to perform various functions. For example, memory 815 may store software used by server 801, such as an operating system 817, application programs 819, and an associated database 811. Alternatively, some or all of server 801 computer executable instructions may be embodied in hardware or firmware (not shown). As described in detail below, database 811 may provide storage for deposits data, interest rate information, NCA information, financial products, the testing environment, the live environment and/or any other suitable information.

Server 801 may operate in a networked environment supporting connections to one or more remote computers, such as terminals 841 and 851. Terminals 841 and 851 may be servers that include many or all of the elements described above relative to server 801. The network connections depicted in FIG. 8 include a local area network (LAN) 825 and a wide area network (WAN) 829, but may also include other networks. When used in a LAN networking environment, computer 801 is connected to LAN 825 through a network interface or adapter 813. When used in a WAN networking environment, server 801 may include a modem 827 or other means for establishing communications over WAN 829, such as Internet 831. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 819, which may be used by server 801, may include computer executable instructions for invoking user functionality related to communication, such as email, short message service (SMS), and voice input and speech recognition applications.

Computing device 801 and/or terminals 841 or 851 may also be mobile terminals including various other components, such as a battery, speaker, and antennas (not shown).

Terminal 851 and/or terminal 841 may be portable devices such as a laptop, cell phone, blackberry, or any other suitable device for storing, transmitting and/or transporting relevant information.

Any information described above in connection with database 811, and any other suitable information, may be stored in memory 815.

One or more of applications 819 may include one or more algorithms that may be used to perform one or more of the following: comparing effects of pairings determining agreement compliance and/or creation of a test environment(s).

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Thus, methods and apparatus for assessing agreement compliance have been provided. Persons skilled in the art will appreciate that the present invention can be practiced by other than the described embodiments, which are presented for purposes of illustration rather than of limitation, and that the present invention is limited only by the claims that follow.

What is claimed is:

1. One or more non-transitory computer-readable media storing computer-executable instructions which, when executed by a processor on a computer system, perform a method for assessing compliance of a financial institution with an agreement, the method comprising:
storing in a machine readable memory:
an attribute associated with the agreement; and
a financial product;
validating the storing;
performing a first pairing of the attribute to the financial product;
monitoring an effect of the first pairing on the financial product;
performing a second pairing of the attribute to the financial product;
monitoring an effect of the second pairing on the financial product;
comparing the effect of the first pairing to the effect of the second pairing; and
based on the comparing, determining whether the financial institution is in compliance with the agreement.

2. The media of claim 1, wherein in the method, the attribute comprises:
an identifier associated with the financial product; and
a pricing scheme.

3. The media of claim 2, wherein in the method, the validating the storing comprises identifying:
an invalid attribute;
an invalid financial product; or
an identifier erroneously associated with the financial product.

4. The media of claim 1, wherein in the method, the validating the storing comprises generating a report, the report comprising a record of:
the attribute; and
a name of an individual responsible for storing the attribute.

5. The media of claim 1, wherein in the method:
the first pairing occurs in a testing environment; and
the second pairing occurs in a live environment.

6. The media of claim 2, wherein in the method:
the first pairing comprises applying the pricing scheme to the financial product in a testing environment; and
the second pairing comprises applying the pricing scheme to the financial product in a live environment.

7. The media of claim 1, wherein in the method, comparing the effect of the first pairing to the effect of the second pairing comprises identifying an invalid pairing.

8. The media of claim 7, wherein in the method, the identifying is based on a detection of an invalid pairing of the attribute and the financial product.

9. The media of claim 6, wherein in the method, the determining of whether the financial institution is in compliance with the agreement comprises determining whether an effect of the pricing scheme on the financial product is in compliance with the agreement.

10. The media of claim 1, wherein in the method:
the attribute is included in a plurality of attributes;
the financial product is included in a plurality of financial products;
the first pairing comprises, in the testing environment, pairing each of the plurality of attributes to at least one of the plurality of financial products;
the second pairing comprises, in the live environment, pairing each of the plurality of attributes to the at least one of the plurality of financial products;
the monitoring the effect of the first pairing comprises monitoring an effect of each first pairing on the at least one financial product;
the monitoring the effect of the second pairing comprises monitoring the effect of each second pairing on the at least one financial product; and
the comparing comprises comparing the effect of each first pairing to the effect of each second pairing.

11. One or more non-transitory computer-readable media storing computer-executable instructions which, when executed by a processor on a computer system, perform a method for implementing an agreement of a financial institution, the method comprising:
storing in a machine readable memory an an attribute of the agreement, the attribute associated with a financial product;
validating the storing;
applying the attribute to the financial product:
in a testing environment; and
in a live environment;
monitoring an effect of the applying on a performance of the financial product; and
based on the effect, determining whether the financial institution is in compliance with the agreement.

12. The media of claim 11, wherein in the method, the validating the storing comprises confirming authorization for the association.

13. The media of claim 11, wherein in the method:
the attribute is included in a plurality of attributes;
the financial product is included in a plurality of financial products; and
the applying comprises applying one of the plurality of attributes to each financial product.

14. The media of claim 13, wherein in the method:
the plurality of financial products comprises a first financial product and a second financial product; and
the applying comprises:
applying the attribute to the first financial product, the attribute associated with the first financial product; and
applying the attribute to the second financial product, the attribute not associated with the second financial product.

15. The media of claim 11, wherein monitoring the effect of the applying comprises comparing an effect of the applying in the testing environment to an effect of the applying in the live environment.

16. The media of claim 11, wherein in the method, the effect of the applying is measured by:
an amount of interest paid;
an amount of interest accrued; or
an amount of total fees assessed.

17. A system for assessing compliance with an agreement of a financial institution, the system comprising:
a transmitter device configured to receive an attribute of the agreement, the attribute being associated with a financial instrument;
a machine readable memory configured to store the attribute and the financial instrument; and
a processor configured to:
apply the attribute to the financial instrument:
in a testing environment; and
in a live environment.
monitor a first effect of the attribute on performance of the financial instrument in the testing environment;
monitor a second effect of the attribute on performance of the financial instrument in the live environment; and
based on the first effect and the second effect, assess compliance of the financial institution with the agreement.

18. The system of claim 17, wherein, the first effect and the second effect correspond to a rate of interest associated with the financial instrument.

19. The system of claim 17, wherein the processor is configured to monitor the second effect and assess whether the performance of the financial instrument is in compliance with the agreement for a duration of the agreement.

20. The system of claim 19, wherein the duration of the agreement is defined by an expiration date associated with the attribute.
